(19) United States
(12) Patent Application Publication
(10) Pub. No.: US 2021/0148944 A1
(43) Pub. Date: May 20, 2021

(54) FLUIDIC DEVICE AND SYSTEM

(71) Applicant: NIKON CORPORATION, Tokyo (JP)

(72) Inventors: Ryo KOBAYASHI, Kawasaki-shi (JP); Naoya ISHIZAWA, Saitama-shi (JP); Taro UENO, Tokyo (JP); Kohma HAYASHI, Tokyo (JP)

(21) Appl. No.: 16/982,992

(22) PCT Filed: Mar. 22, 2018
(86) PCT No.: PCT/JP2018/011423

§ 371 Date: Jan. 20, 2021

(51) Int. Cl. G01N 35/10; B01L 3/00; F16K 99/00

(52) U.S. Cl. CPC G01N 35/1097; F16K 99/0001; B01L 3/502715

(57) ABSTRACT

A fluidic device that can feed a fluid along a flow path without causing a leakage of gas is provided. The fluidic device includes: a first substrate and a second substrate which are bonded to each other at a bonding surface and at least one of which includes a flow path that is open on the bonding surface; and three or more valve portions that are disposed at a position facing the flow path and that are configured to adjust a flow of a fluid in the flow path by deformation. The first substrate includes a through-hole penetrating the first substrate at positions facing the valve portions. The valve portions are disposed on the same circumference centered on an axis extending in a normal direction of the bonding surface.

### TECHNICAL FIELD

The present invention relates to a fluidic device and a system.

### BACKGROUND

Recently, development of micro-total analysis systems (μ-TASs) for the purpose of increasing speed, efficiency, and the degree of integration of tests in the field of in-vitro diagnosis or microminiaturization of test equipment has attracted attention, and active study thereof has progressed around the world.

A μ-TAS is better than test equipment in the related art because a μ-TAS can measure and analyze a small amount of a sample, can be carried, can be used and discarded at a low cost, and the like.

μ-TASs have attracted attention as systems with high usefulness when a reagent of a high price is used or when small amounts and large numbers of samples are tested.

A device including a flow path and a pump disposed in the flow path has been reported as an element of a μ-TAS (Non-Patent Document 1). In such a device, a plurality of solutions are mixed in the flow path by injecting the plurality of solutions into the flow path and activating the pump.

### RELATED ART DOCUMENT

### Non-Patent Document

[Non-Patent Document 1] Jong Wook Hong, Vincent Studer, Giao Hang, W French Anderson and Stephen R Quake, Nature Biotechnology 22, 435-439 (2004)

### SUMMARY OF INVENTION

According to a first aspect of the invention, there is provided a fluidic device including: a first substrate and a second substrate which are bonded to each other at a bonding surface and at least one of which includes a flow path that opens on the bonding surface; and three or more valve portions that are disposed at a position facing the flow path and that are configured to adjust a flow of a fluid in the flow path by deformation, wherein the first substrate includes a through-hole penetrating the first substrate at positions facing the valve portions, and the valve portions are disposed on the same circumference centered on an axis extending in a normal direction of the bonding surface.

According to a second aspect of the invention, there is provided a system including: the fluidic device according to the first aspect of the present invention; and a drive device configured to press-drive the valve portions of the fluidic device, wherein the drive device includes: a movable member that is movable between a first position at which the valve portion is pressed to close the flow path with a tip of the movable member via the through-hole and a second position at which the movable member retreats in a direction of the axis from the first position to open the flow path when the fluidic device is set in the drive device; a rotation device that is rotatable around the axis; and a cam portion that is disposed on the same circumference in the rotation device as the valve portions of the fluidic device, supports a base end of the movable member, and is configured to move the movable member in the direction of the axis.

### BRIEF DESCRIPTION OF THE DRAWINGS

FIG. 1 is a sectional view illustrating a principal part of a system SYS including a fluidic device 100A according to an embodiment.

FIG. 2 is a plan view of the system SYS according to the embodiment from the fluidic device 100A side.

FIG. 3 is a diagram schematically illustrating a configuration of a rotational drive source 61 and a rotation device 62 according to the embodiment.

FIG. 4 is a diagram illustrating development of a cam portion 65 according to the embodiment around an axis C.

FIG. 5 is a timing chart illustrating the relationship between cam position and open/closed state of a flow path 40 in a six-phase type pumping cycle for each of valve portions V11 to V13 according to the embodiment.

FIG. 6 is a sectional view in a first phase of a solution feed cycle according to the embodiment.

FIG. 7 is a sectional view in a second phase of the solution feed cycle according to the embodiment.

FIG. 8 is a sectional view in a third phase of the solution feed cycle according to the embodiment.

FIG. 9 is a sectional view in a fourth phase of the solution feed cycle according to the embodiment.

FIG. 10 is a sectional view in a fifth phase of the solution feed cycle according to the embodiment.

FIG. 11 is a sectional view in a sixth phase of the solution feed cycle according to the embodiment.

FIG. 12 is a timing chart illustrating the relationship between cam position and open/closed state of the flow path 40 in a three-phase type pumping cycle for each of valve portions V11 to V13 according to the embodiment.

FIG. 13 is a timing chart illustrating the relationship between cam position and open/closed state of the flow path 40 in a four-phase type pumping cycle for each of valve portions V11 to V13 according to the embodiment.

FIG. 14 is a timing chart illustrating the relationship between cam position and open/closed state of the flow path 40 in a five-phase type pumping cycle for each of valve portions V11 to V13 according to the embodiment.

FIG. 15 is a plan view schematically illustrating the fluidic device and the system according to the embodiment.

FIG. 16 is a plan view of a magnetic sensor which is included in a detection portion 3 according to the embodiment.

FIG. 17 is a plan view schematically illustrating the fluidic device and the system according to the embodiment.

FIG. 18 is a plan view schematically illustrating the fluidic device and the system according to the embodiment.

FIG. 19 is a plan view schematically illustrating the fluidic device and the system according to the embodiment.

FIG. 20 is a diagram illustrating the relationship between drive frequency of a pump P and signal intensity which is detected by the magnetic sensor in an antigen-antibody reaction according to the embodiment.

FIG. 21 is a diagram illustrating the relationship between drive frequency of the pump P and inter-sensor unevenness (a C.V. (%) value) in an antigen-antibody reaction according to the embodiment.

FIG. 22 is a sectional view illustrating a principal part in a modified example of the system SYS including the fluidic device 100A according to the embodiment.

### DESCRIPTION OF EMBODIMENTS

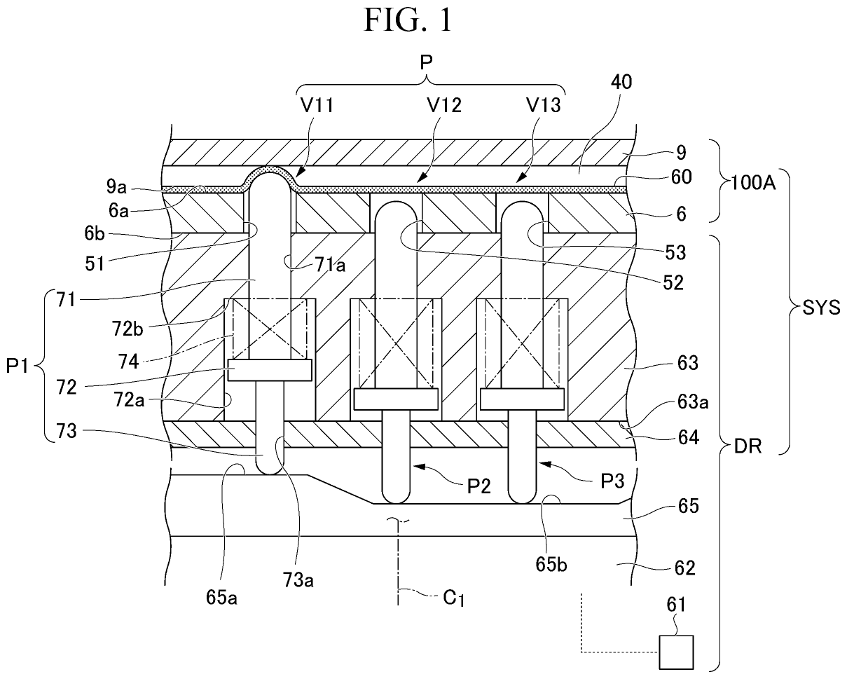

Hereinafter, a fluidic device and a system according to an embodiment of the invention will be described with reference to FIGS. 1 to 22.

In the drawings which are used in the following description, in order to facilitate understanding of features, feature parts may be enlarged for the purpose of convenience, and sizes, proportions, and the like of elements may not be the same as actual ones.

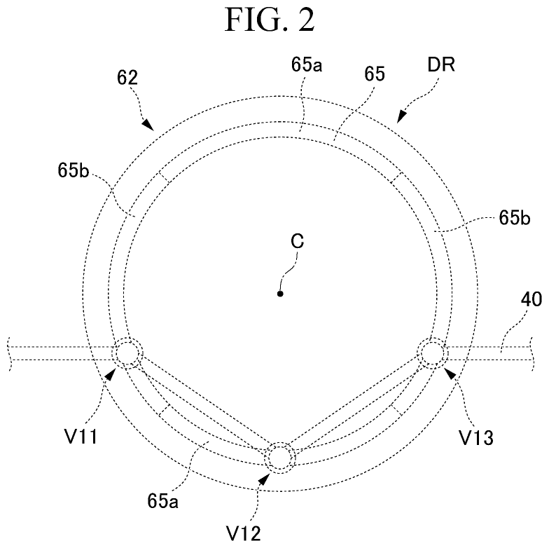

FIG. 1 is a sectional view illustrating a principal part of a system SYS including a fluidic device 100A according to an embodiment. FIG. 2 is a plan view of the system SYS from the fluidic device 100A side.

As illustrated in FIG. 1, the system SYS includes a fluidic device 100A and a drive device DR. The fluidic device 100A is set in the drive device DR for use. The fluidic device 100A is disposed in the drive device DR, and is used in a state in which it is fixed or pressed. The drive device DR includes pressing pins (movable members) P1 to P3 that face valve portions which will be described later when the fluidic device 100A is set therein.

The fluidic device 100A according to this embodiment includes a device that detects a sample material which is a detection object included in a test sample by hybridization, an immune reaction and an enzyme reaction, or the like. The sample material is, for example, biomolecules or particles such as nucleic acid, DNA, RNA, peptides, proteins, and extracellular endoplasmic reticula

The fluidic device 100A includes a first substrate 6 and a second substrate 9. The first substrate 6 and the second substrate 9 are, for example, plate-shaped substrates and are formed of, for example, a resin material (a hard material such as polypropylene or polycarbonate). The first substrate 6 and the second substrate 9 may also be referred to as a first substrate and a second substrate. The fluidic device 100A includes the first substrate and the second substrate which are bonded to each other at a bonding surface. For example, the first substrate 6 and the second substrate 9 are bonded to each other by welding techniques such as ultrasonic welding and laser welding. The first substrate 6 and the second substrate 9 include, for example, a plurality of (for example, two) positioning holes (not illustrated) that penetrate the substrates in a bonding direction and are used for positioning in an in-plane direction. The first substrate 6 and the second substrate 9 can be stacked (multilayered) in a state in which they are positioned in the in-plane direction by inserting shaft members into the positioning holes (not illustrated). At least one of the first substrate 6 and the second substrate 9 includes a groove that forms a flow path 40 when the two substrates are bonded to each other on the bonding surface. In this embodiment, the second substrate 9 includes the flow path 40 that opens on the bonding surface 9a with the first substrate 6. The flow path 40 is, for example, a groove with a width or a depth of about several μm to several hundreds of mm

In the following description, it is assumed that the first substrate 6 and the second substrate 9 are disposed along a horizontal plane and the first substrate 6 is disposed on the bottom side (on the drive device DR side) of the second substrate 9. The first substrate 6 may be also referred to as an upper plate and the second substrate 9 may be referred to as a base plate. This is merely defining the horizontal direction and the vertical direction for the purpose of convenience of explanation, and does not define a direction at the time of use of the fluidic device 100A and the system SYS according to this embodiment.

The fluidic device 100A includes a pump P that is used to feed a solution in the flow path 40. The pump P includes valve portions V11 to V13 that are disposed with intervals therebetween. In this embodiment, three valve portions V11 to V13 are provided. The pump P has to include at least three valve portions but may include, for example, three to twelve valve portions. The valve portions V11 to V13 are formed of a flexible member 60. The flexible member 60 is an elastic member. The flexible member 60 is formed in a sheet shape with a size including three valve portions V11 to V13, and is provided on a top surface 6a of the first substrate 6 facing the flow path 40. When the flexible member 60 is a single sheet common to the valve portions V11 to V13, a fluidic device can be manufactured as a stacked structure in which a sheet is provided between the first substrate 6 and the second substrate 9. Accordingly, there is consistency with a general process of manufacturing a fluidic device, in which plate-shaped or sheet-shaped substrates having a groove or a recess formed therein are stacked and bonded. The flexible member 60 may be provided separately for each of the valve portions V11 to V13. That is, the valve portions V11 to V13 may independently include flexible members 60. In all cases including the case in which the flexible member 60 is provided in a sheet shape and the case in which the flexible member 60 is provided separately for each of the valve portions V11 to V13, it is preferable that the flexible member be a molded product which has been integrally molded with the first substrate 6. By integrally molding the flexible member 60 with the first substrate 6, it is possible to enhance manufacturing efficiency. The diameter of each of the valve portions V11 to V13 ranges from about several μm to several hundreds of mm. It is preferable that the diameter be 1.2 times to three times the width of the flow path 40. For example, when the width of the flow path is 1.5 mm, it is preferable that each valve used herein have a diameter equal to or greater than 2 mm.

In the first substrate 6, exposing portions 51 to 53 are formed at positions facing the valve portions V11 to V13. The exposing portions 51 to 53 are formed as through-holes penetrating the first substrate 6 in a vertical direction (a thickness direction of the first substrate 6). That is, the valve portions V11 to V13 are formed of parts of the flexible member 60 which is exposed to the outside (the bottom side) by the exposing portions 51 to 53.

For example, a material that is deformed by pressure such as an elastic member can be used as a material of the flexible member 60, and examples thereof include a thermoplastic elastomer such as a polyolefin-based elastomer, a styrene-based elastomer, and a polyester-based elastomer.

As illustrated in FIG. 2, the valve portions V11 to V13 are disposed at intervals on the same circumference centered on an axis C extending in a normal direction of the bonding surface 9a. For example, the valve portions V11 to V13 are disposed at intervals of 75° centered on the axis C. A part of the flow path 40 is formed in a <- shaped (V-shaped) path in a plan view connecting the valve portion V11 and the valve portion V12 and connecting the valve portion V12 and the valve portion V13. It is preferable that the distance between the valves be two times to five times the diameter of each valve.

An angle between a straight line connecting the valve portion V11 and the valve portion V12 which are adjacent to each other in a circumferential direction and a straight line connecting the valve portion V12 and the valve portion V13 which are adjacent to each other in the circumferential direction is 105° when the valve portions V11 to V13 are disposed at intervals of 75°.

The drive device DR includes the pressing pins P1 to P3, a rotational drive source 61, a rotation device 62, and holding plates 63 and 64. The pressing pins P1 to P3 have the same configuration and thus only the pressing pin P1 will be described below. The pressing pin P1 includes a pressing portion 71, a flange portion 72, and a sliding portion 73 which are sequentially arranged from the tip side. The pressing portion 71 has a cylindrical shape extending in the direction of the axis C and a tip thereof is formed in a semispherical shape. The diameter of the pressing portion 71 is less than the diameter of the exposing portions 51 to 53.

The flange portion 72 is formed in a disc shape with a diameter greater than the diameter of the pressing portion 71. The sliding portion 73 is formed in a cylindrical shape extending in the direction of the axis C downward from the flange portion 72. The lower end of the sliding portion 73 is formed in a semispherical shape. The diameter of the sliding portion 73 is less than the diameter of the pressing portion 71. The lower end of the sliding portion 73 is supported from below by a cam portion 65 which is formed in the rotation device 62 as will be described later.

The holding plates 63 and 64 are positioned with respect to each other and are integrally bonded in the vertical direction. The holding plate 63 is set to be in contact with the bottom surface 6b of the first substrate 6 when the valve portions V11 to V13 of the fluidic device 100A are driven. The holding plate 63 includes holding holes 71a and cavity portions 72a at positions facing the valve portions V11 to V13 when the first substrate 6 has been set. The holding holes 71a penetrate the holding plate 63 in the direction of the axis C. The holding holes 71a hold the pressing portions 71 of the pressing pins P1 to P3 to be movable in the direction of the axis C. The cavity portions 72a are recesses with a bottom 72b extending the direction of the axis C and open on the bottom surface 63a of the holding plate 63. The diameter of each cavity portion 72a is greater than the diameter of the corresponding flange portion 72.

The holding plate 64 includes holding holes 73a which are formed coaxially with the holding holes 71a and the cavity portions 72a. The holding holes 73a penetrate the holding plate 64 in the direction of the axis C. The holding holes 73a hold the sliding portions 73 of the pressing pins P1 to P3 to be movable in the direction of the axis C.

The length of the pressing pins P1 to P3 is a length with which the tips of the pressing portions 71 can press the valve portions V11 to V13 from below via the exposing portions 51 to 53 to come into contact with the bottom surface of the flow path 40 and to block the flow path 40 when the lower ends of the sliding portions 73 are located at a first position at which the lower ends are supported by peak portions 65a of the cam portion 65, similarly to the pressing pin P1 illustrated in FIG. 1. The length of the pressing pins P1 to P3 is a length with which the tips of the pressing portions 71 are inserted into the exposing portions 51 to 53 to open the flow path 40 in a state in which the tips do not press the valve portions V11 to V13 when the lower ends of the sliding portions 73 are located at a second position at which the lower ends are supported by valley portions 65b of the cam portion 65, similarly to the pressing pins P2 and P3 illustrated in FIG. 1.

The thickness and the position in the direction of the axis C of the flange portions 72 are set to a thickness and a position with which the flange portions 72 do not come into contact with the bottom surfaces 72b of the cavity portions 72a when the pressing pins P1 to P3 are located at the first position and do not come into contact with the holding plate 64 when the pressing pins P1 to P3 are located at the second position.

In each cavity portion 72a, a compression spring 74 of which the top in the length direction is in contact with the bottom surface 72b and the bottom is in contact with the top surface of the corresponding flange portion 72 is provided as a biasing member in a compressed state. The compression springs 74 of which the top is in contact with the bottom surface 72b apply a downward force to the pressing pins P1 to P3 located at the first position and the second position by normally pressing the flange portions 72 downward.

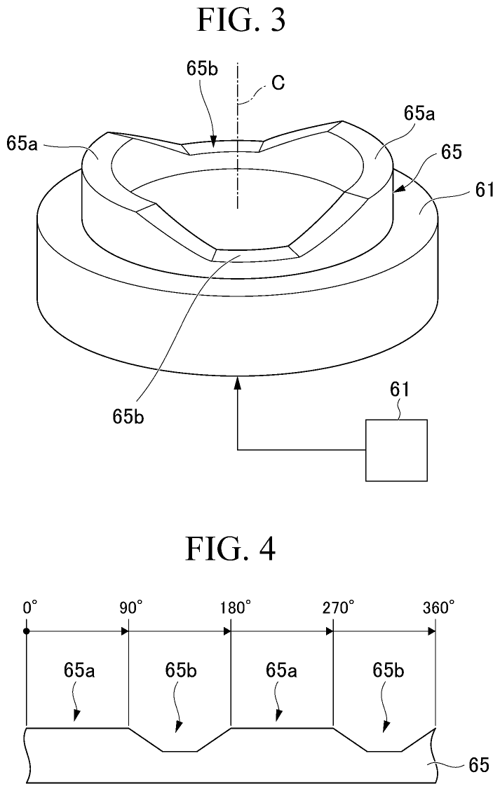

FIG. 3 is a diagram schematically illustrating a configuration of the rotational drive source 61 and the rotation device 62. The rotation device 62 is formed in a disc shape. The rotation device 62 rotates around the axis C with rotational driving of the rotational drive source 61 such as a motor. The cam portion 65 is provided to protrude on the top surface of the rotation device 62. The cam portion 65 protrudes in a ring shape around the axis C. The cam portion 65 is disposed on the same circumference as the valve portions V11 to V13 and supports the sliding portions 73 of the pressing pins P1 to P3 from below. Since the pressing pins P1 to P3 are normally pressed downward by the compression springs 74, the sliding portions 73 of the pressing pins P1 to P3 slide over the top surface of the cam portion 65 when the rotation device 62 rotates around the axis C.

The cam portion 65 includes the peak portions 65a that support the pressing pins P1 to P3 at the first position and the valley portions 65a that are formed lower than the peak portions 65a and supports the pressing pins P1 to P3 at the second position. The peak portions 65a and the valley portions 65b are alternately disposed at intervals of 90°.

FIG. 4 is a diagram illustrating development of the cam portion 65 around the axis C. In FIG. 4, for example, an end in the circumferential direction of the peak portion 65a is set as a reference.

As illustrated in FIG. 4, in the cam portion 65, the peak portions 65a are disposed in a range of 0° to 90° and a range of 180° to 270°, and the valley portions 65b are disposed in a range which is greater than 90° and less than 180° and a range which is greater than 270° and less than 360°.

In the cam portion 65 according to this embodiment, the peak portions 65a and the valley portions 65b are disposed at two positions to perform a solution feed cycle in which a solution is fed in the flow path 40 two times as will be described later while the rotation device 62 rotates one turn. In order to enable the solution feed cycle to be performed two times while the rotation device 62 rotates one turn, it is preferable that the valve portions V11 to V13 be disposed in an angle range equal to or less than 180°, and it is more preferable that the total range in which the valve portions V11 to V13 are disposed at intervals of 75° be equal to or less than 150°.

The valley portions 65b include inclined portions which are provided between areas located at the lowermost position (an area in which the pressing pins P1 to P3 are located at the second position) and the peak portions 65a. When the sliding portions 73 slide over the inclined portions, the position at which the pressing pins P1 to P3 are supported can be smoothly changed between the peak portions 65a and the valley portions 65b. When the sliding portions 73 are supported by the inclined portions, the pressing portions 71 of the pressing pins P1 to P3 move downward and thus the valve portions V11 to V13 are elastically deformed to partially release blocking of the flow path 40. In the following description, it is assumed that the case in which the sliding portions 73 are supported by the inclined portions is an open state in which at least a part of the flow path 40 is open.

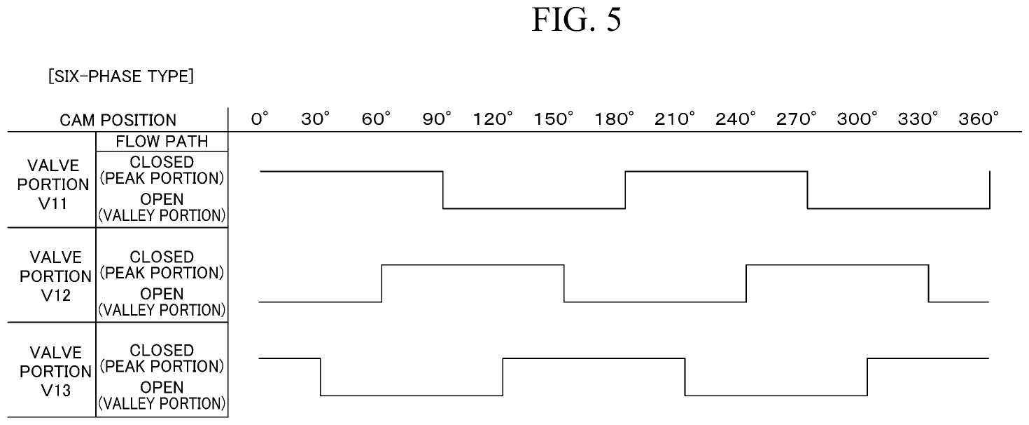

The operation of the pump P in the system SYS having the aforementioned configuration will be described below with reference to FIGS. 5 to 14.

[Six-Phase Type Pumping Cycle]

In this embodiment, an example in which a solution is fed in the flow path 40 by switching the open/closed states of the valve portions V11 to V13 to six phases will be described with reference to FIGS. 5 to 11.

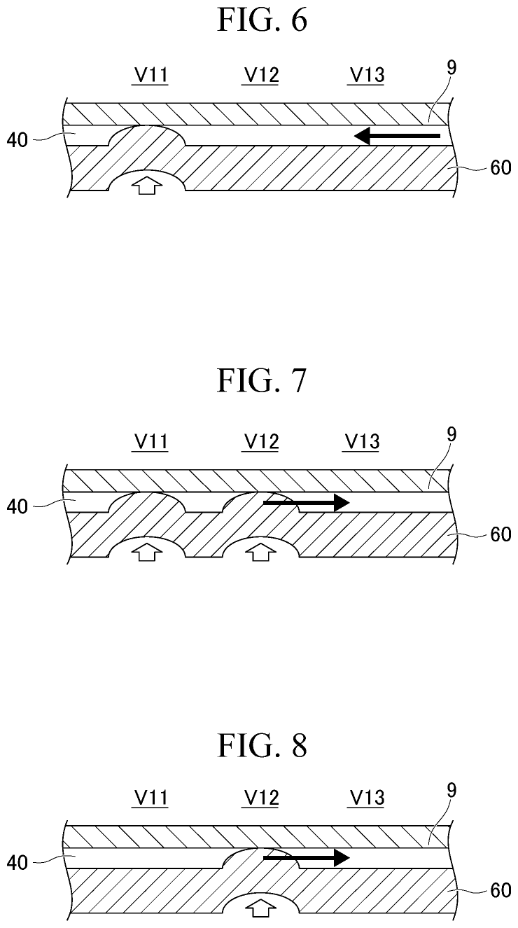

FIG. 5 is a timing chart illustrating the relationship between the cam position at which the pressing pins P1 to P3 are supported by the cam portion 65 illustrated in FIG. 4 when a solution is fed in a six-phase type pumping cycle and the open/closed state of the flow path 40 for each of the valve portions V11 to V13. FIGS. 6 to 11 are diagrams illustrating the open/closed states of the valve portions V11 to V13 and a flow of a solution in the flow path 40. In FIGS. 6 to 11, the first substrate 6 and the pressing pins P1 to P3 are not illustrated.

Angles described below are angles with respect to the reference in the cam portion 65 illustrated in FIG. 5 unless otherwise mentioned. In FIGS. 6 to 11, a flow direction of a solution in the flow path 40 will be described with the valve portion V11 side as a left side and with the valve portion V13 side as a right side.

(First Phase)

FIG. 6 is a sectional view in a first phase of the solution feed cycle.

The first phase is performed in a range of 30° to 60°. In the first phase, the valve portion V11 blocks the flow path 40 and the valve portions V12 and V13 open the flow path 40. Accordingly, the solution in the flow path 40 is divided by the valve portion V11.

(Second Phase)

FIG. 7 is a sectional view in a second phase of the solution feed cycle.

The second phase is performed in a range of 60° to 90°. In the second phase, the valve portion V12 blocks the flow path 40 with respect to the first phase. Since the valve portion V11 still blocks the flow path 40, the solution on the right side of the valve portion V11 is fed rightward as indicated by an arrow when the valve portion V12 blocks the flow path 40.

(Third Phase)

FIG. 8 is a sectional view in a third phase of the solution feed cycle.

The third phase is performed in a range of 90° to 120°. In the third phase, the valve portion V11 opens the flow path 40 with respect to the second phase. Since the valve portion V12 still blocks the flow path 40, the solution on the left side of the valve portion V11 moves rightward to the valve portion V12 as indicated by an arrow to compensate for an increase in volume of the flow path 40 due to release of elastic deformation of the valve portion V11 when the valve portion V11 opens the flow path 40.

(Fourth Phase)

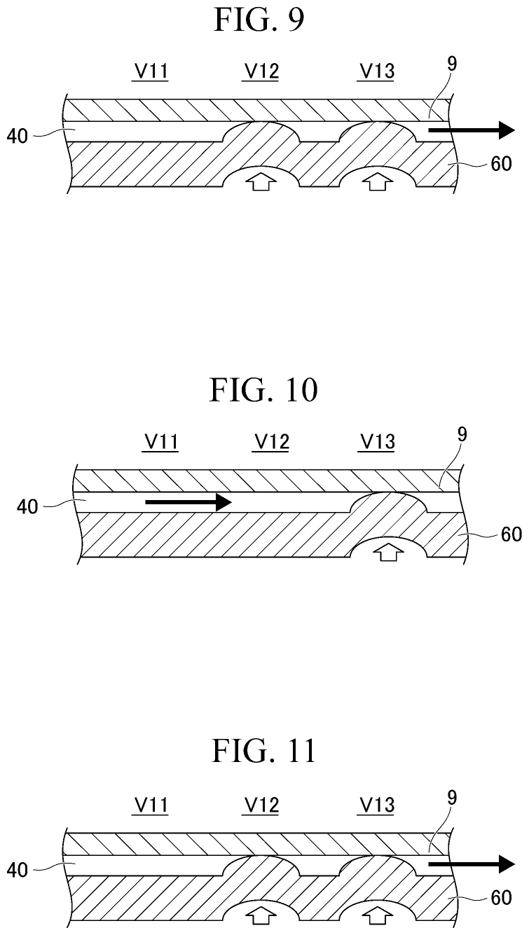

FIG. 9 is a sectional view in a fourth phase of the solution feed cycle.

The fourth phase is performed in a range of 120° to 150°. In the fourth phase, the valve portion V13 blocks the flow path 40 with respect to the third phase. Since the valve portion V12 still blocks the flow path 40, the solution on the right side of the valve portion V12 is fed rightward as indicated by an arrow when the valve portion V13 blocks the flow path 40.

(Fifth Phase)

FIG. 10 is a sectional view in a fifth phase of the solution feed cycle.

The fifth phase is performed in a range of 180° to 210°. In the fifth phase, the valve portion V12 opens the flow path 40 with respect to the fourth phase. Since the valve portion V13 still blocks the flow path 40, the solution on the left side of the valve portion V12 moves rightward to the valve portion V13 as indicated by an arrow to compensate for an increase in volume of the flow path 40 due to release of elastic deformation of the valve portion V12 when the valve portion V12 opens the flow path 40.

(Sixth Phase)

FIG. 11 is a sectional view in a sixth phase of the solution feed cycle.

The sixth phase is performed in a range of 240° to 270°. In the sixth phase, the valve portion V11 blocks the flow path 40 with respect to the fifth phase. Accordingly, the solution of the flow path 40 on the left side of the valve portion V13 is partitioned by the valve portion V11. Since the valve portion V13 still blocks the flow path 40, the solution in the flow path 40 moves leftward as indicated by an arrow when the valve portion V11 blocks the flow path 40.

Thereafter, by returning the solution feed cycle to the first phase and causing the valve portion V13 to open the flow path 40, the solution on the right side of the valve portion V13 moves leftward to compensate for an increase in volume of the flow path 40 due to release of elastic deformation of the valve portion V13.

Thereafter, by repeating the first to sixth phases, the solution in the flow path 40 can be fed rightward (from the valve portion V11 side to the valve portion V13 side).

[Three-Phase Type Pumping Cycle]

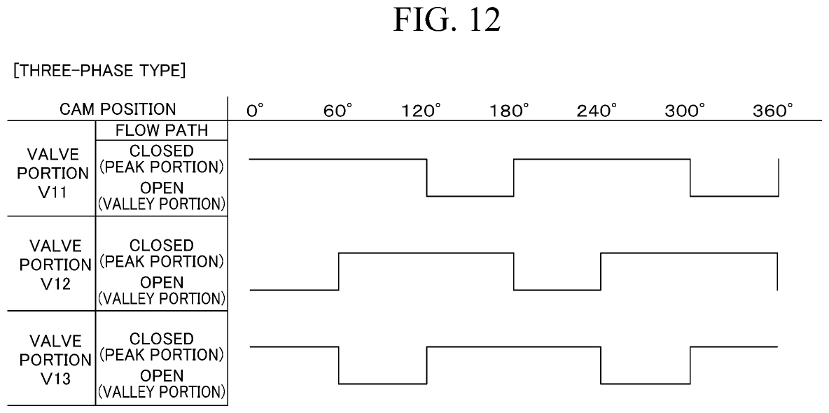

In this embodiment, an example in which a solution is fed in the flow path 40 by switching the open/closed states of the valve portions V11 to V13 to three phases will be described with reference to FIG. 12.

FIG. 12 is a timing chart illustrating the relationship between the cam position at which the pressing pins P1 to P3 are supported by the cam portion 65 when a solution is fed in a three-phase type pumping cycle and the open/closed state of the flow path 40 for each of the valve portions V11 to V13.

In the case of the three-phase type pumping cycle, in the cam portion 65, the peak portions 65a are disposed in a range of 0° to 120° and the range of 180° to 300°, and the valley portions 65b are disposed in a range which is greater than 120° and less than 180° and a range which is greater than 300° and less than 360°.

(First Phase)

A first phase is performed in a range of 0° to 60°. In the first phase, similarly to the sixth phase of the six-phase type pumping cycle (see FIG. 11), the valve portions V11 and V13 block the flow path 40 and the valve portion V12 opens the flow path 40. Accordingly, the solution in the flow path 40 is divided by the valve portions V11 and V13.

(Second Phase)

A second phase is performed in a range of 60° to 120°. In the second phase, similarly to the second phase of the six-phase type pumping cycle (see FIG. 7), the valve portion V12 blocks the flow path 40 and the valve portion V13 opens the flow path 40 with respect to the first phase. Since the valve portion V11 still blocks the flow path 40, the solution on the right side of the valve portion V11 is fed rightward as indicated by an arrow when the valve portion V12 blocks the flow path 40.

(Third Phase)

A third phase is performed in a range of 120° to 180°. In the third phase, similarly to the fourth phase of the six-phase type pumping cycle (see FIG. 9), the valve portion V11 opens the flow path 40 and the valve portion V13 blocks the flow path 40 with respect to the second phase. Since the valve portion V11 opens the flow path 40, the solution in the flow path 40 on the left side of the valve portion V11 moves rightward to the valve portion V12 to compensate for an increase in volume of the flow path 40 due to release of elastic deformation of the valve portion V11. Since the valve portion V12 still blocks the flow path 40, the solution on the right side of the valve portion V12 is fed rightward as indicated by an arrow when the valve portion V13 blocks the flow path 40.

Thereafter, the solution feed cycle returns to the first phase, the valve portion V12 opens the flow path 40, and the valve portion V11 blocks the flow path 40 with respect to the third phase. Accordingly, the solution in the flow path 40 is partitioned by the valve portions V11 and V13. When the valve portion V11 blocks the flow path 40, some of the solution in the flow path 40 moves leftward as indicated by an arrow and some of the solution moves rightward to the valve portion V13 to compensate for an increase in volume of the flow path 40 due to release of elastic deformation of the valve portion V12.

Thereafter, by repeating the first to third phases, the solution in the flow path 40 can be fed rightward (from the valve portion V11 side to the valve portion V13 side).

[Four-Phase Type Pumping Cycle]

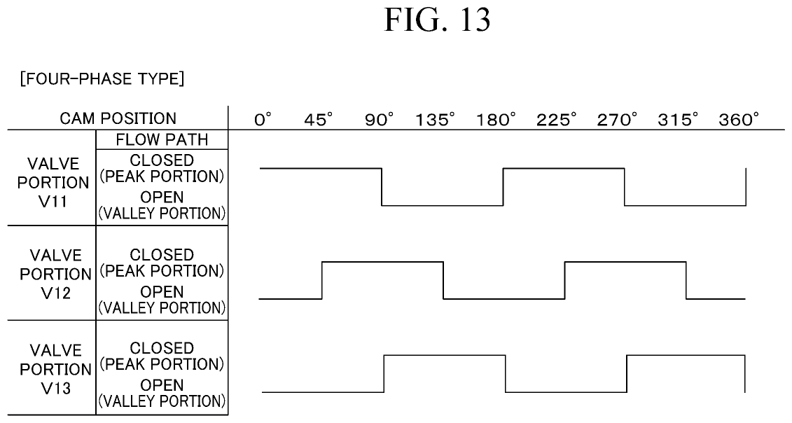

In this embodiment, an example in which a solution is fed in the flow path 40 by switching the open/closed states of the valve portions V11 to V13 to four phases will be described with reference to FIG. 13.

FIG. 13 is a timing chart illustrating the relationship between the cam position at which the pressing pins P1 to P3 are supported by the cam portion 65 when a solution is fed in a four-phase type pumping cycle and the open/closed state of the flow path 40 for each of the valve portions V11 to V13.

In case of the four-phase type pumping cycle, in the cam portion 65, similarly to the six-phase type pumping cycle illustrated in FIG. 4, the peak portions 65a are disposed in a range of 0° to 90° and a range of 180° to 270°, and the valley portions 65b are disposed in a range which is greater than 90° and less than 180° and the range which is greater than 270° and less than 360°.

(First Phase)

A first phase is performed in a range of 0° to 45°. In the first phase, similarly to the first phase of the six-phase type pumping cycle (see FIG. 6), the valve portion V11 blocks the flow path 40 and the valve portions V12 and V13 open the flow path 40. Accordingly, the solution in the flow path 40 is divided by the valve portion V11.

(Second Phase)

A second phase is performed in a range of 45° to 90°. In the second phase, similarly to the second phase of the six-phase type pumping cycle (see FIG. 7), the valve portion V12 blocks the flow path 40 with respect to the first phase. Since the valve portion V11 still blocks the flow path 40, the solution on the right side of the valve portion V11 is fed rightward as indicated by an arrow when the valve portion V12 blocks the flow path 40.

(Third Phase)

A third phase is performed in a range of 90° to 135°. In the third phase, similarly to the fourth phase of the six-phase type pumping cycle (see FIG. 9), the valve portion V11 opens the flow path 40 and the valve portion V13 blocks the flow path 40 with respect to the second phase. Since the valve portion V11 opens the flow path 40, the solution in the flow path 40 on the left side of the valve portion V11 moves rightward to the valve portion V12 to compensate for an increase in volume of the flow path 40 due to release of elastic deformation of the valve portion V11. Since the valve portion V12 still blocks the flow path 40, the solution on the right side of the valve portion V12 is fed rightward as indicated by an arrow when the valve portion V13 blocks the flow path 40.

(Fourth Phase)

A fourth phase is performed in a range of 135° to 180°. In the fourth phase, similarly to the fifth phase of the six-phase type pumping cycle (see FIG. 10), the valve portion V12 opens the flow path 40 with respect to the third phase. Since the valve portion V13 still blocks the flow path 40, the solution on the left side of the valve portion V12 moves rightward to the valve portion V13 as indicated by an arrow to compensate for an increase in volume of the flow path 40 due to release of elastic deformation of the valve portion V12 when the valve portion V12 opens the flow path 40.

Thereafter, the solution feed cycle returns to the first phase, the valve portion V13 opens the flow path 40, and the valve portion V11 blocks the flow path 40 with respect to the fourth phase. Accordingly, the solution in the flow path 40 is partitioned by the valve portion V11. When the valve portion V11 blocks the flow path 40, some of the solution in the flow path 40 moves leftward. When the valve portion V13 opens the flow path 40, the solution on the right side of the valve portion V13 moves leftward to compensate for an increase in volume of the flow path 40 due to release of elastic deformation of the valve portion V13.

Thereafter, by repeating the first to fourth phases, the solution in the flow path 40 can be fed rightward (from the valve portion V11 side to the valve portion V13 side).

(Five-Phase Type Pumping Cycle)

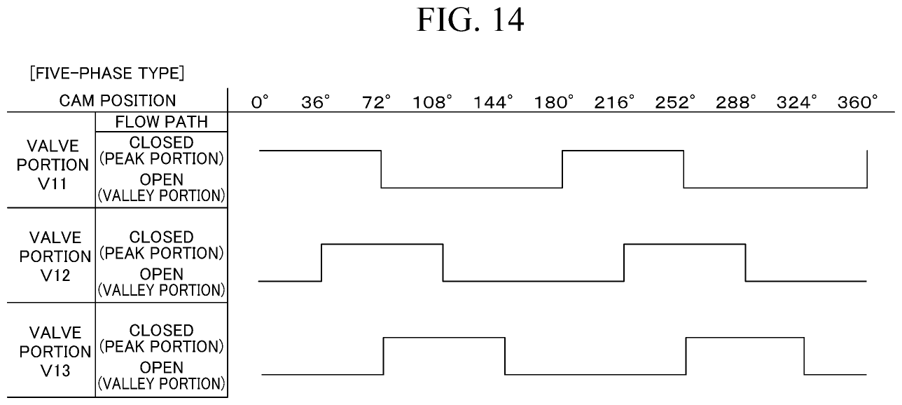

In this embodiment, an example in which a solution is fed in the flow path 40 by switching the open/closed states of the valve portions V11 to V13 to five phases will be described with reference to FIG. 14.

FIG. 14 is a timing chart illustrating the relationship between the cam position at which the pressing pins P1 to P3 are supported by the cam portion 65 when a solution is fed in a five-phase type pumping cycle and the open/closed state of the flow path 40 for each of the valve portions V11 to V13.

In case of the five-phase type pumping cycle, in the cam portion 65, the peak portions 65a are disposed in a range of 0° to 72° and the range of 180° to 252°, and the valley portions 65b are disposed in a range which is greater than 72° and less than 180° and the range which is greater than 252° and less than 360°.

(First to Fourth Phases)

In the five-phase type pumping cycle, the first to fourth phases are different from those of the four-phase type pumping cycle in only the angle of the cam portion 65 at which the flow path 40 is opened and blocks, and are the same as those in a drive pattern of the valve portions V11 to V13. That is, the first phase of the five-phase type pumping cycle is performed in a range of 0° to 36°, and the second phase is performed in a range of 36° to 72°. The third phase of the five-phase type pumping cycle is performed in a range of 72° to 108°, and the fourth phase is performed in a range of 108° to 144°.

(Fifth Phase)

The fifth phase is performed in a range of 144° to 180°. In the fifth phase, the valve portion V13 opens the flow path 40 with respect to the fourth phase. Accordingly, all the valve portions V11 to V13 open the flow path 40.

Thereafter, by repeating the first to fifth phases, the solution in the flow path 40 can be fed rightward (from the valve portion V11 side to the valve portion V13 side).

As described above, in the fluidic device 100A and the system SYS according to this embodiment, since the valve portions V11 to V13 are disposed on the same circumference centered on the axis C and the flow path 40 is opened/blocked by synchronously driving the valve portions V11 to V13 via the cam portion 65 and the pressing pins P1 to P3 which rotate around the axis C by rotational driving of the rotational drive source 61, it is possible to feed a solution in the flow path 40 without causing leakage of a fluid unlike a case in which the valve portions V11 to V13 are driven using a fluid such as air.

In the fluidic device 100A and the system SYS according to this embodiment, since the rotational drive source 61 is electrically driven, it is not necessary to provide a gas compression device such as a gas cylinder or a compressor unlike a case in which the valve portions V11 to V13 are driven using a fluid and to extend versatility. When the rotational drive source is used, it is possible to easily change a feed speed of a solution by adjusting a rotation speed thereof to change drive periods of the valve portions V11 to V13.

In the fluidic device 100A and the system SYS according to this embodiment, by appropriately selecting a rotation device 62 including a cam portion 65 with a different disposing pattern of the peak portions 65a and the valley portions 65b, it is possible to arbitrarily select a drive pattern such as a six-phase type, a three-phase type, or a four-phase type as described above.

[Examples of Fluidic Device and System]

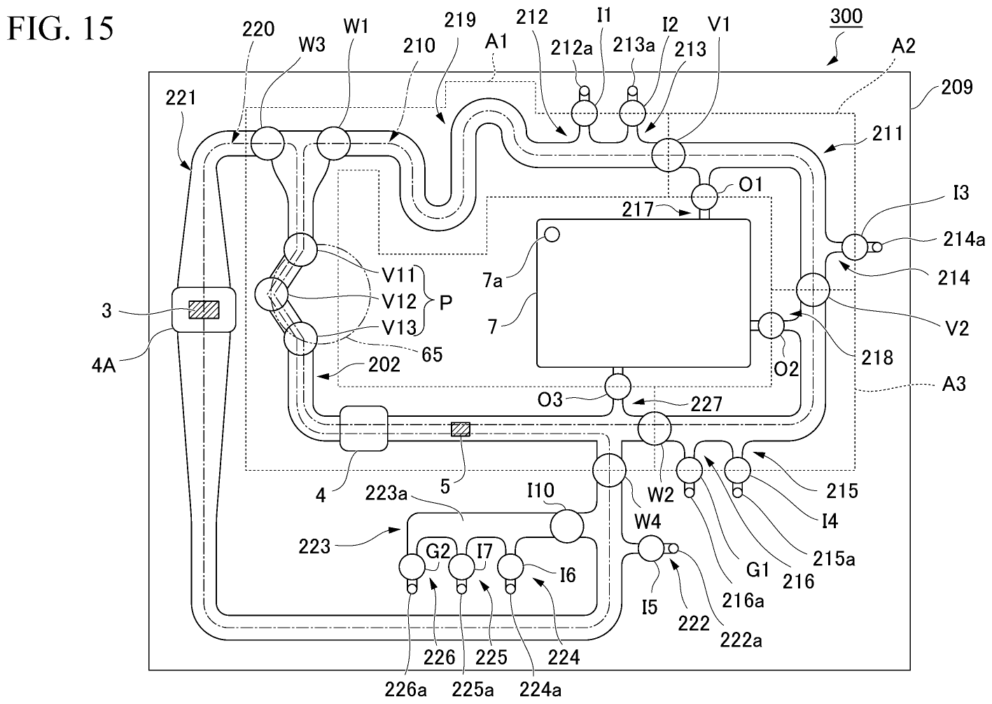

Examples of the fluidic device and the system will be described below with reference to FIGS. 15 to 21.

FIG. 15 is a plan view schematically illustrating a fluidic device 300.

As illustrated in FIG. 15, the fluidic device 300 includes a substrate 209 in which a flow path and valve portions V11 to V13 are formed. The fluidic device 300 includes a first circulating flow path 210 and a second circulating flow path 220 that are formed in the substrate 209 and that circulate a solution including a sample material. The first circulating flow path 210 and the second circulating flow path 220 include a shared flow path 202 which are shared thereby. The first circulating flow path 210 includes an unshared flow path 211 which is not shared by the second circulating flow path 220, and the second circulating flow path 220 includes an unshared flow path 221 which is not shared by the first circulating flow path 210.

(Shared Flow Path)

The shared flow path 202 connects ends of the unshared flow path 211 of the first circulating flow path 210. The shared flow path 202 connects ends of the unshared flow path 221 of the second circulating flow path 220. The shared flow path 202 includes a pump P, a first capturing portion 4, and an assisting material detecting portion 5.

A discharge flow path 227 connected to a waste solution tank 7 is connected to the shared flow path 202. A discharge flow path valve O3 is provided in the discharge flow path 227.

The pump P is constituted by the aforementioned three valve portions V11 to

V13 which are disposed in parallel in the flow path. The valve portions V11 to V13 are driven by the aforementioned drive device DR (only the cam portion 65 is illustrated in FIGS. 15 to 18). The valve portions V11 to V13 are disposed on the same circumference as that of the cam portion 65. The pump P can control a solution feed direction of a solution in the circulating flow paths by controlling opening/blocking of the three valve portions V11 to V13. The number of valve portions V11 to V13 may be four or more. The first capturing portion 4 captures and collects a sample material in the solution circulating in the first circulating flow path 210. The configuration of the first capturing portion 4 includes, for example, a magnetic force source such as a magnet (not illustrated). The magnetic force source is disposed in the vicinity of the shared flow path 202 from below.

The assisting material detecting portion 5 is provided to detect a marker material for assisting with detection of a sample material (a detection assisting material) by binding the marker material to the sample material. When an enzyme is used as the marker material, deterioration of the enzyme may occur with the elapse of a storage time and there is concern about a decrease in detection efficiency in a detection portion 3 including a magnetic sensor provided in the second circulating flow path 220. The assisting material detecting portion 5 detects the marker material and measures the degree of deterioration of the enzyme.

(First circulating flow path) The first circulating flow path 210 includes a plurality of valves V1, V2, W1, and W2 in the unshared flow path 211. Out of these valves, the valves V1, V2, and W2 serve as quantification valves. The valves W1 and W2 serve as unshared flow path end valves. That is, the valve W2 serves as a quantification valve and also serves as an unshared flow path end valve.

The quantification valves V1, V2, and W2 are disposed such that sections of the first circulating flow path 210 which are partitioned by the quantification valves have a predetermined volume. The quantification valves V1 and V2 partition the first circulating flow path 210 into a first quantification section A1, a second quantification section A2, and a third quantification section A3.

The first quantification section A1 includes the shared flow path 202.

Introduction flow paths 212 and 213 are connected to the unshared flow path 211 of the first quantification section A1. An introduction flow path 214 and a discharge flow path 217 are connected to the second quantification section A2. An introduction flow path 215, a discharge flow path 218, and an air flow path 216 are connected to the third quantification section A3.

The introduction flow paths 212, 213, 214, and 215 are provided to introduce different solutions into the first circulating flow path 210. Introduction flow path valves Il, 12, 13, and 14 that open and block the corresponding introduction flow paths are provided in the introduction flow paths 212, 213, 214, and 215. Solution-introduction inlets 212a, 213a, 214a, and 215a that open on the surface of the substrate 209 are provided at ends of the introduction flow paths 212, 213, 214, and 215.

The air flow path 216 is provided to discharge or introduce air from or into the first circulating flow path 210. An air flow path valve G1 that opens and blocks the flow path is provided in the air flow path 216.

An air-introduction inlet 216a that opens on the surface of the substrate 209 is provided at an end of the air flow path 216.

The discharge flow paths 217 and 218 are provided to discharge a solution from the first circulating flow path 210. Discharge flow path valves O1 and O2 that open and block the corresponding discharge flow paths are provided in the discharge flow paths 217 and 218. The discharge flow paths 217 and 218 are connected to a waste solution tank 7. An outlet 7a that is connected to an external suction pump (not illustrated) and opens on the surface of the substrate for the purpose of negative-pressure suction is provided in the waste solution tank 7. In the fluidic device 300 according to this embodiment, the waste solution tank 7 is disposed an area inside the first circulating flow path 210. Accordingly, it is possible to achieve a decrease in size of the fluidic device 300.

A meandering portion 219 is provided in the unshared flow path 211 of the first quantification section A1. The meandering portion 219 is a part of the unshared flow path 211 of the first quantification section A1 and is a part that is formed to meander to the right and left sides. The meandering portion 219 increases the volume of the unshared flow path 211 of the first quantification section A1.

(Second Circulating Flow Path)

The second circulating flow path 220 includes valves W3 and W4 serving as unshared flow path end valves and a second capturing portion 4A in the unshared flow path 221. The second capturing portion 4A captures and collects a sample material in a solution flowing in the unshared flow path 221. The second capturing portion 4A may be configured to capture carrier particles bound to a sample material. Since the second capturing portion 4A captures the sample material or carrier particles bound to the sample material, the sample material can be collected from the solution flowing in the unshared flow path 221. Since the fluidic device 300 includes the second capturing portion 4A, it is possible to effectively realize condensation, cleaning, and feed of the sample material.

The carrier particles are magnetic beads or magnetic particles. Other examples of the second capturing portion 4A include a column including a filler that can be bound to the carrier particles and an electrode that can attract the carrier particles. When the sample material is hexane, the second capturing portion 4A may be an hexane array to which hexane hybridizing with the hexane is fixed.

The carrier particles are, for example, particles which can react with a sample material which serves as a detection object. Examples of the reaction of the carrier particles with the sample material include binding between the carrier particles and the sample material, adsorption between the carrier particles and the sample material, modification of the carrier particles due to the sample material, and chemical change of the carrier particles due to the sample material. Examples of the carrier particles include magnetic beads, magnetic particles, gold nanoparticles, agarose beads, and plastic beads.

Carrier particles having a material, which can be bound to or adsorbed on the sample material, on surfaces thereof may be used to bind the sample material to the carrier particles. For example, when carrier particles are bound to protein, an antibody on the surface of a carrier particle can be bound to protein using carrier particles having an antibody, which can be bound to protein, on the surface thereof. A material which can be bound to the sample material can be appropriately selected depending on the type of the sample material. Examples of a combination of a material which can be bound to or adsorbed onto a sample material/the sample material or a site included in the sample material include various receptor proteins/ligands thereof such as biotin-binding protein such as avidin and streptavidin/biotin, active ester group such as succinimidyl group/amino group, acetyl iodide group/amino group, maleimide group/thiol group (—SH), maltose-binding protein/maltose, G protein/guanine nucleotide, polyhistidine peptide/metal ion of nickel, cobalt, or the like, glutathione-S-transferase/glutathione, DNA-binding protein/DNA, antibody/antigen molecules (epitope), calmodulin/calmodulin-binding peptides, ATP-binding protein/ATP, and estradiol receptor protein/estradiol.

The sample material captured by the second capturing portion 4A is detected by the detection portion 3 including a magnetic sensor. In an example in which a sample material is detected, the sample material may be bound to a detection assisting material that assists with detection of the sample material. When a marker material (a detection assisting material) is used, the sample material is bound to the detection assisting material by circulating the sample material along with the marker material in the second circulating flow path 220 and mixing them.

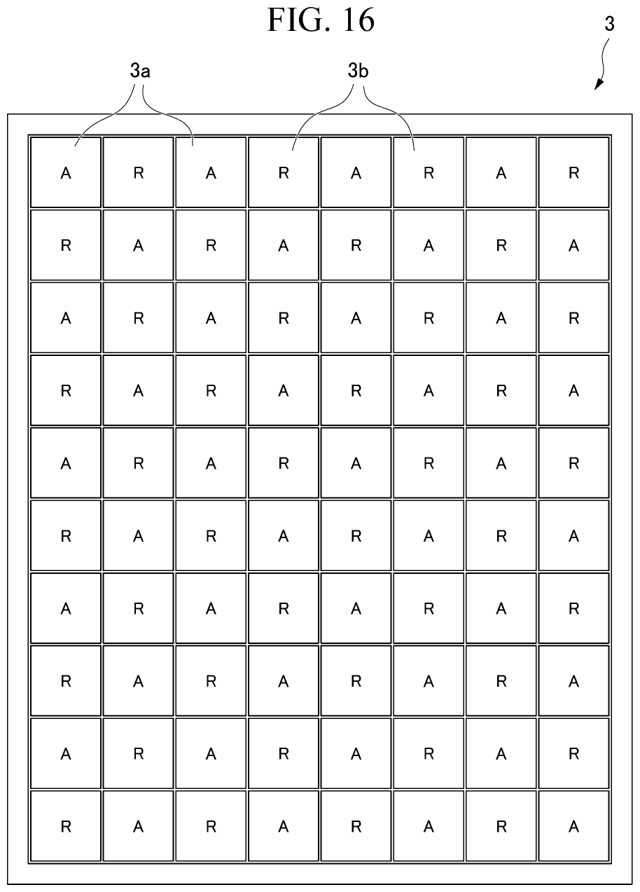

FIG. 16 is a plan view of a magnetic sensor which is included in the detection portion 3.

As illustrated in FIG. 16, the detection portion 3 includes a total of 80 magnetic sensors 3a and 3b which are arranged in a 8×10 lattice shape (matrix shape). The magnetic sensors 3a and 3b are alternately arranged in the longitudinal direction and the lateral direction. An antibody A such as a human tissue immunostaining antibody (anti-EGFR antibody) is fixed to each magnetic sensor 3a. The magnetic sensors 3b indicated by R are for reference and no antibody is fixed thereto. The magnetic sensors 3a and 3b are provided to face the unshared flow path 221 in the second capturing portion 4A.

Examples of the marker material (the detection assisting material) include a fluorochrome, fluorescent beads, a fluorescent protein, quantum dots, gold nanoparticles, a biotin, an antibody, an antigen, an energy-absorbing material, a radioactive isotope, a chemiluminescent element, and an enzyme.

Examples of the fluorochrome include FAM (carboxyfluorescein), JOE (6-carboxy 4′,5′-dichloro 2′,7′-dimethoxyfluorescein), MC (fluorescein isothiocyanate), TET (tetrachlorofluorescein), HEX (5′-hexachlorofluorescein-CE phosphoramidite), Cy3, Cy5, Alexa568, and Alexa647.

Examples of the enzyme include alkaline phosphatase, peroxidase, and β-galactosidase.

An introduction flow path 222 and a collecting flow path 223 are connected to the unshared flow path 221 of the second circulating flow path 220. A solution reserving portion 223a and a valve I10 are provided in the collecting flow path 223. The valve I10 is located between the solution reserving portion 223a and the second circulating flow path 220. Introduction flow paths 224 and 225 and an air flow path 226 are connected to the solution reserving portion 223a. Introduction flow path valves 15, 16, and 17 are provided in a path of the introduction flow paths 222, 224, and 225, and introduction inlets 222a, 224a, and 225a are provided at ends thereof. Similarly, an air flow path valve G2 is provided in the path of the air flow path 226, and an air-introduction inlet 226a is provided at an end thereof.

(Detection Method)

A mixing method, a capturing method, and a detection method of a sample material using the fluidic device 300 according to this embodiment. In the detection method according to this embodiment, an antigen (a sample material or a biomolecule) which is a detection object included in a test sample is detected by an immune reaction and an enzyme reaction.

First, the valves V1, V2, and W2 of the first circulating flow path 210 are closed, the valve W1 is opened, and the unshared flow path end valves W3 and W4 of the second circulating flow path 220 are closed. Accordingly, the first circulating flow path 210 is partitioned into the first quantification section A1, the second quantification section A2, and the third quantification section A3.

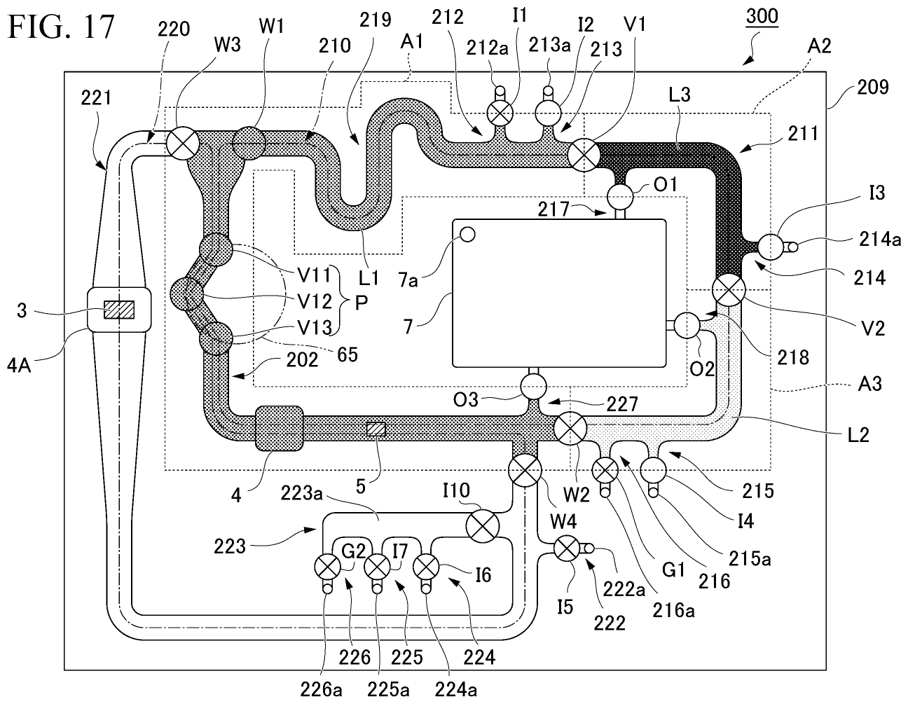

Subsequently, as illustrated in FIG. 17, a sample solution (a first solution) L1 including a sample material is introduced into the first quantification section A1 from the introduction flow path 213 and is quantified (a sample solution introducing step). A second reagent solution L3 including a marker material (a detection assisting material) is introduced into the second quantification section A2 from the introduction flow path 214 (a second reagent solution introducing step). A first reagent solution (a second solution) L2 including carrier particles is introduced into the third quantification section A3 from the introduction flow path 215 and is quantified (a first reagent solution introducing step).

In this embodiment, the sample solution L1 includes an antigen which is a detection object (a sample material). Examples of the sample solution include a body fluid such as blood, urine, saliva, blood plasma, or serum, a cellular extract, and a tissue-crushed solution.

In this embodiment, magnetic particles are used as the carrier particles included in the first reagent solution L2. An antibody A1 (for example, biotin-binding protein such as streptavidin) which is singularly bound to an antigen (a sample material) which is the detection object is fixed to the surfaces of the magnetic particles.

In this embodiment, the second reagent solution L3 contains an antibody A2 which is singularly bound to the antigen which is the detection object. For example, biotin (a detection assisting material) is fixed to and marked on the antibody A2.

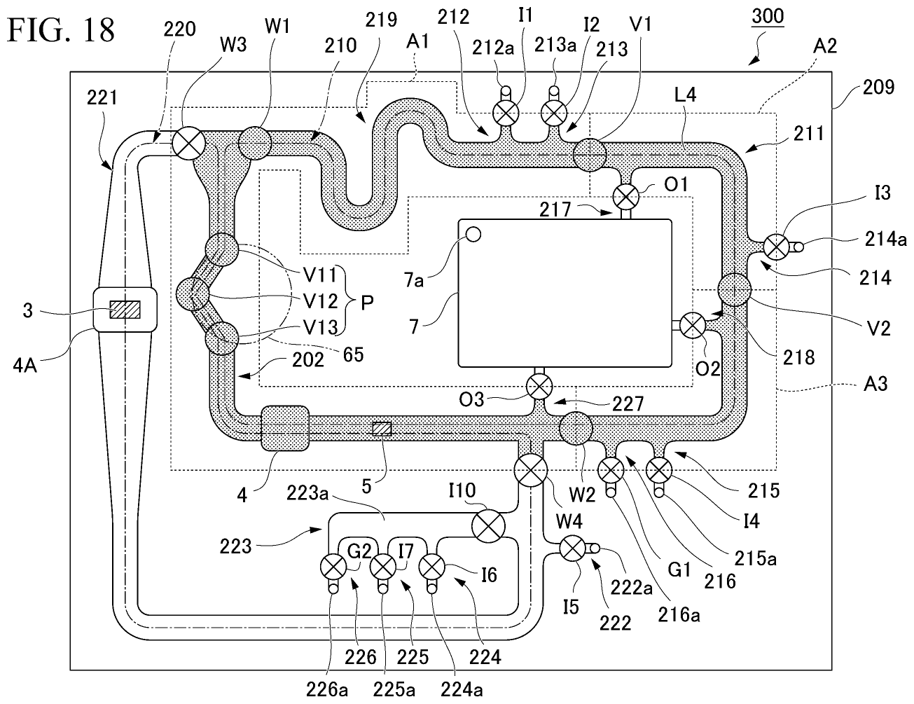

Subsequently, as illustrated in FIG. 18, the sample solution L1, the first reagent solution L2, and the second reagent solution L3 are circulated and mixed in the first circulating flow path 210 to acquire a mixed solution L4 by opening the valves V1, V2, and W2 and driving the pump P of the shared flow path 202 (a first circulation step). By mixing the sample solution L1, the first reagent solution L2, and the second reagent solution L3, the antibody A2 having biotin fixed thereto is bound to the antigen and the antibody A1 fixed to the carrier particles is bound to the antigen via biotin. Accordingly, carrier-antigen-protein complexes are produced in the mixed solution L4.

In the first circulation step, an extra marker material which is not used to produce the carrier-antigen-protein complex is captured by the assisting material detecting portion 5.

After binding between the sample material and the carrier particles has progressed sufficiently, a magnet for capturing magnetic particles in the first capturing portion 4 is brought close to the flow path in a state in which the mixed solution L4 is circulated in the first circulating flow path 210. Accordingly, the first capturing portion 4 captures the carrier-antigen-protein complex. The complex is captured on the inner wall surface of the first circulating flow path 210 in the first capturing portion 4 and is separated from a liquid component.

Subsequently, although a diagram illustrating the step is omitted, the air flow path valve G1 and the discharge flow path valves O1, O2, and O3 are opened in a state in which the carrier-antigen-protein complex is captured in the first capturing portion 4, and negative-pressure suction from the outlet 7a of the waste solution tank 7 is performed to discharge the liquid component (a mixed solution discharging step). Accordingly, the mixed solution is removed from the shared flow path 202 and the carrier-antigen-protein complex is separated from the mixed solution.

Subsequently, although a diagram illustrating the step is omitted, the air flow path valve G1 and the discharge flow path valves O1, O2, and O3 are blocked and a cleaning solution is introduced into the first circulating flow path 210 from the introduction flow path 212. By driving the pump P of the shared flow path 202, the cleaning solution is circulated in the first circulating flow path 210 and the carrier-antigen-protein complex is cleaned. After circulation of the cleaning solution for a predetermined time has been performed, the cleaning solution is discharged to the waste solution tank 7.

The cycle of introduction, circulation, and discharge of the cleaning solution may be performed a plurality of times. By repeatedly performing introduction, circulation, and discharge of the cleaning solution, it is possible to enhance removal efficiency of unnecessary substance.

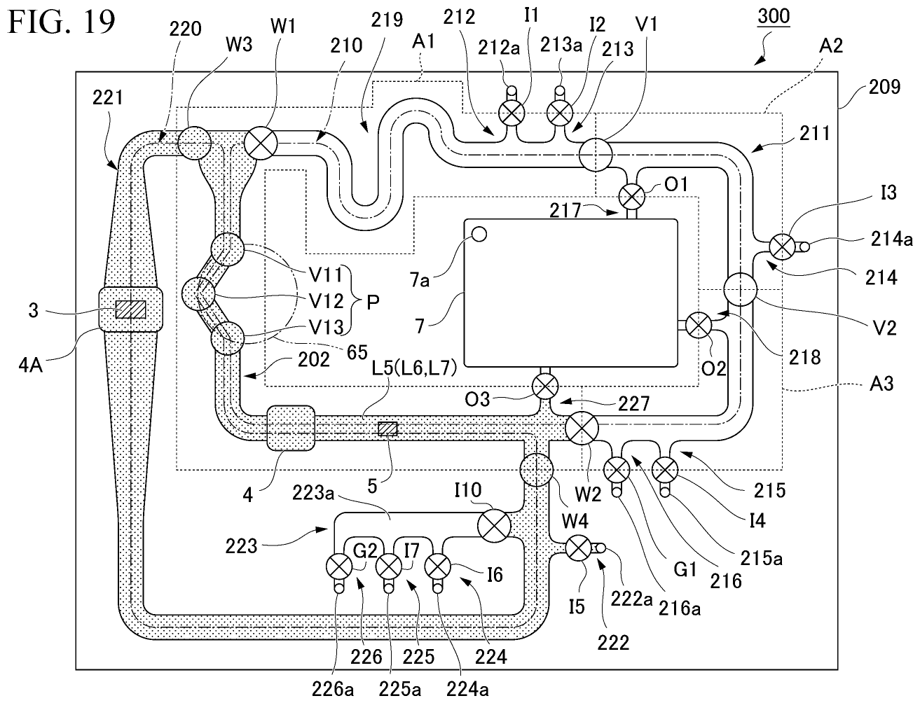

Subsequently, as illustrated in FIG. 19, the valves W1 and W2 of the first circulating flow path 210 are blocked, the unshared flow path end valves W3 and W4 of the second circulating flow path 220 are opened, a feed solution L5 is introduced from the introduction flow path 222 to fill the second circulating flow path 220 with the feed solution L5. Subsequently, by releasing capturing of the carrier-antigen-protein complex in the first capturing portion 4 and driving the pump P, the carrier-antigen-protein complex is fed to the second circulating flow path 220.

In the carrier-antigen-protein complex fed to the second circulating flow path 220, the antigen is bound to the antibody A fixed to the magnetic sensor 3a in the detection portion 3.

Subsequently, the valve W4 is blocked, the air flow path valve G2 of the air flow path 226 and the discharge flow path valve O3 of the discharge flow path 227 are opened, and negative-pressure suction from the outlet 7a is performed. Accordingly, the liquid component (waste solution) of the feed solution L5 separated from the carrier-antigen-protein complex is discharged clockwise from the second circulating flow path.

Thereafter, by detecting signals acquired from a plurality of magnetic sensors 3a, it is possible to measure an amount of magnetic particles (that is, antigen) adsorbed on the antibody A fixed to the magnetic sensors 3a.

In the aforementioned detection method, the sample solution L1 including an antigen, the first reagent solution L2 including carrier particles having the antibody A1 fixed thereto, and the second reagent solution L3 including an antibody A2 are mixed to produce a carrier-antigen-protein complex and the carrier-antigen-protein complex is adsorbed on an antibody A fixed to the magnetic sensors 3a, but the detection method is not limited to that order. For example, first, the sample solution L1 including an antigen and the second reagent solution L3 including an antibody A2 are circulated and mixed in the circulating flow path 220 and an antigen having the antibody A2 fixed thereto is bound to the antibody A (antigen-antibody mixture).

Then, after the circulating flow path 220 has been drained, the carrier particles may be adsorbed on the antigen by circulating the first reagent solution L2 including the carrier particles having the antibody A1 fixed thereto in the circulating flow path 220 and binding the antibody A1 to the antibody A2 fixed to the antigen bound to the antibody A in the magnetic sensors 3a (an antigen-antibody reaction). When this order is employed, it is possible to measure an amount of magnetic particles (that is, antigen) adsorbed on the antibody A fixed to the magnetic sensors 3a by detecting signals acquired from the plurality of magnetic sensors 3a.

When the detection portion 3 includes, for example, a member transmitting light instead of the magnetic sensors and an imaging device is provided in an external device, the antigen adsorbed on the carrier particles and the antibody A are bound with an enzyme as the antibody A2, the unshared flow path end valves W3 and W4 of the second circulating flow path 220 are opened, a substrate solution L6 is introduced from the introduction flow path 224, and the second circulating flow path 220 is filled with the substrate solution L6 (a substrate solution introducing step). For example, the substrate solution L6 includes 3-(2′-spiroadamantane)-4-methoxy-4-(3″-phosphoryloxy) phenyl-1,2-dioxetane (AMPPD), 4-Aminophenyl Phosphate (pAPP), or 4-Nitrophenyl Phosphate (pNPP) which serves as a substrate when the enzyme is an alkaline phosphatase (enzyme). The substrate solution L6 reacts with the enzyme of a carrier-antigen-enzyme complex in the second circulating flow path 220. By circulating the substrate solution L6 and the carrier-antigen-enzyme complex in the second circulating flow path 220, the substrate solution L6 can be made to react with the enzyme of the carrier-antigen-enzyme complex to generate a color with the second capturing portion 4A. By imaging this color with an imaging device, it is possible to detect a reaction product.

[Verification of Detection Variation in Magnetic Sensors Depending on Drive Frequency of Pump P]

Verification of an influence which the drive frequency of the pump P gives to detection unevenness (variation) in the magnetic sensors will be described below.

This verification employed the sequences of adsorbing carrier particles on an antigen by circulating and mixing the sample solution L1 including an antigen and the second reagent solution L3 including an antibody A1 marked with biotin in the circulating flow path 220 to bind the antigen having the antibody A1 fixed thereto to the antibody A and circulating the first reagent solution L2 including carrier particles having streptavidin fixed thereto in the circulating flow path 220 to bind streptavidin to biotin of the antibody A1 fixed to the antigen bound to the antibody A in the magnetic sensors 3a. The sequences were performed by assigning conditions 1 to 3 set in the specifications described in Table 1 to an L18 orthogonal table, and a variation coefficient (C.V. (%)) was calculated by averaging ten high points of a signal intensity in a plurality of magnetic sensors 3a. The drive frequency of the pump P in Table 1 represents the number of times the first to fifth phases are driven for one second.

In the conditions, an EGFR antigen with a concentration of 25 ng/ml was quantified by 10 μl and used as an antigen, an EGFR antigen was quantified by 57 μl and used as the antibody A2, and magnetic particles of ϕ30 nm having streptavidin fixed thereto were quantified by 67 μl and used as the antibody A1.

TABLE 1

| | Condition 1 | | Condition 2 | | Condition 3 | |
|---|---|---|---|---|---|---|
| Pump driving type | Five-phase type | | Five-phase type | | Five-phase type | |
| Temperature | 25° | C. | 37° | C. | 45° | C. |
| Pump frequency in | 20 | Hz | 5 | Hz | 1 | Hz |
| mixing antigen and | | | | | | |
| antibody | | | | | | |
| Antigen and | 30 | sec | 60 | sec | 120 | sec |
| antibody mixing | | | | | | |
| time | | | | | | |
| Pump frequency in | 20 | Hz | 5 | Hz | 1 | Hz |
| antigen-antibody | | | | | | |
| reaction | | | | | | |
| Pump frequency in | 1 | Hz | 5 | Hz | 20 | Hz |
| detecting | | | | | | |
| magnetism | | | | | | |

| | | | |
|---|---|---|---|
| Rotation direction | One direction | Inverted every | Inverted every 30 |
| | | minute | seconds |

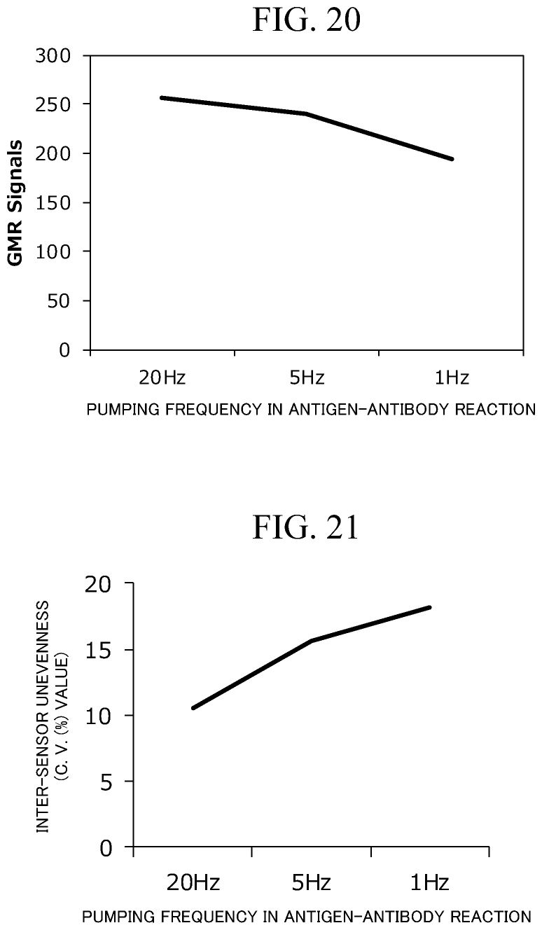

FIG. 20 is a diagram illustrating the relationship between drive frequency of the pump P and signal intensity which is detected by a magnetic sensor in an antigen-antibody reaction. As illustrated in FIG. 20, it could be ascertained that the signal level of the magnetic sensor becomes higher as the drive frequency of the pump P becomes higher.

FIG. 21 is a diagram illustrating the relationship between drive frequency of the pump P and inter-sensor unevenness (C.V. (%) value) in an antigen-antibody reaction. As illustrated in FIG. 21, it could be ascertained that the unevenness between the magnetic sensors becomes smaller as the drive frequency of the pump P becomes higher and the unevenness decreases to a half, for example, when the drive frequency of the pump P is 20 Hz in comparison with a case in which the drive frequency is 1 Hz.

While exemplary embodiments of the invention have been described above with reference to the accompanying drawings, the invention is not limited to the embodiments. All shapes, combinations, and the like of the constituent members described in the above embodiments are only examples and can be modified in various forms on the basis of a design request or the like without departing from the gist of the invention.

For example, the configuration in which three valve portions are provided has been described in the aforementioned embodiments, but a configuration in which four or more valve portions are provided may be employed. The configuration in which the cam portion 65 can perform the pumping cycle two times while the rotation device 62 rotates by one turn has been described in the aforementioned embodiments, but the invention is not limited thereto and a configuration in which the pumping cycle can be performed once or less while the rotation device 62 rotates by one turn or a configuration in which the pumping cycle can be performed three or more times may be employed.

The valve portions V11 to V13 have a circular shape in the aforementioned embodiments, but the valve portions may have a cylindrical shape. The shapes and sizes of the valve portions V11 to V13 may be the same or different between the valve portions V11 to V13. For example, when three valve portions V11 to V13 are used, it is preferable that the valve portion (V12) located at the center be larger than the valve portions (V11 and V13) located at both ends, in that more solution can be made to flow and solution feed efficiency is higher.

The exposing portions (through-holes) 51 to 53 are provided to correspond to the valve portions V11 to V13 in the aforementioned embodiments, but the invention is not limited thereto. For example, a configuration which one exposing portion (through-hole) with a size including the valve portions V11 to V13 is provided and the valve portions V11 to V13 are driven via the one through-hole may be employed. When this configuration is employed, it is possible to further relax position accuracy of the exposing portion (through-hole) and to further enhance manufacturing efficiency of the fluidic device in comparison with an exposing portion (through-hole) is provided for each of the valve portions V11 to V13.

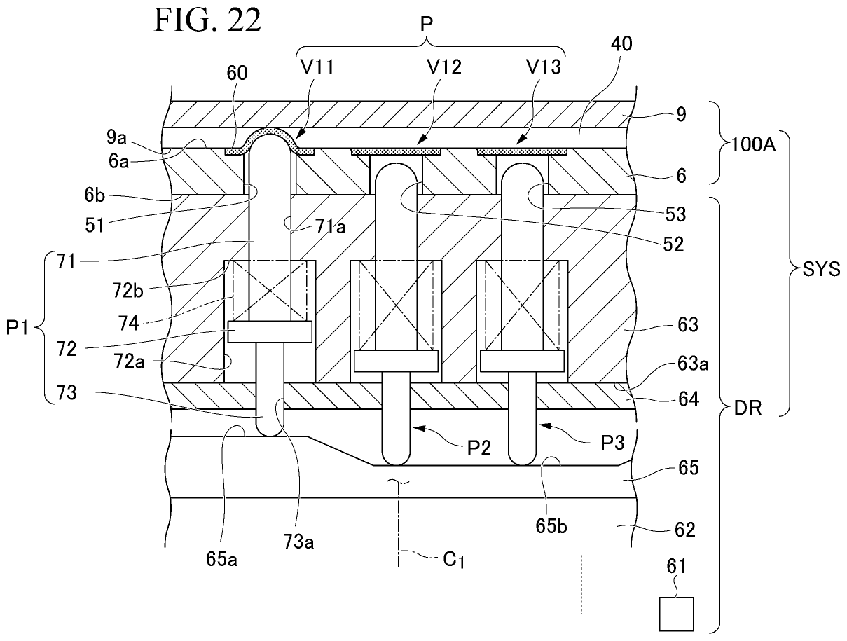

A configuration in which the flexible member 60 is formed in a sheet shape with a size including three valve portions V11 to V13 has been described in the aforementioned embodiments, but the invention is not limited thereto. For example, as illustrated in FIG. 22, the flexible member 60 is divided and independently provided for each of the three valve portions V11 to V13 may be employed.

A configuration in which the valve portions V11 to V13 are disposed at intervals of 75° has been described in the aforementioned embodiments, but the invention is not limited thereto and, for example, the valve portions may be disposed at intervals of 45° and the peak portions 65a and the valley portions 65b in the cam portion 65 may be disposed at intervals of 90°. When this configuration is employed, the angle between a straight line connecting the valve portion V11 and the valve portion V12 which are adjacent to each other in the circumferential direction and a straight line connecting the valve portion V12 and the valve portion V13 which are adjacent to each other in the circumferential direction is 135°. In this case, all the valve portions V11 to V13 can open the flow path 40 at the second position at which the lower ends of the sliding portions 73 of the pressing pins P1 to P3 are supported by the valley portion 65b in the cam portion 65. By setting a state in which all the valve portions V11 to V13 open the flow path 40 as an origin state, the pump P can be considered to be a part of the flow path 40 in the origin state, and control can be facilitated at the time of quantification or at the time of processing a waste solution.

### DESCRIPTION OF THE REFERENCE SYMBOLS

6 . . . First substrate
9 . . . Second substrate
40 . . . Flow path
51 to 53 . . . Exposing portion (through-hole)
60 . . . Flexible member (elastic member)
62 . . . Rotation device
65 . . . Cam portion
65a . . . Peak portion
65b . . . Valley portion
100A
300 . . . Fluidic device
DR . . . Drive device
P1 to P3 . . . Pressing pin (movable member)
V11 to V13 . . . Valve portion
SYS . . . System

1. A fluidic device comprising:
a first substrate and a second substrate which are bonded to each other at a bonding surface and at least one of which includes a flow path that opens on the bonding surface; and
three or more valve portions that are disposed at a position facing the flow path and that are configured to adjust a flow of a fluid in the flow path by deformation,
wherein the first substrate includes a through-hole penetrating the first substrate at positions facing the valve portions, and
wherein the valve portions are disposed on the same circumference centered on an axis extending in a normal direction of the bonding surface.

2. The fluidic device according to claim 1,
wherein the fluidic device is a fluidic device that is set in a drive device including a pressing portion for use,
wherein the pressing portion is able to be inserted in the through-hole, and
wherein the valve portions are each deformed by press driving using the pressing portion and are configured to feed the fluid along the flow path by synchronization of a pattern of the pressing.

3. The fluidic device according to claim 1 or 2,
wherein the valve portions are disposed at an equal interval on the same circumference.

4. The fluidic device according to any one of claims 1 to 3,
wherein the valve portions are an elastic member.

5. The fluidic device according to any one of claims 1 to 4,
wherein the valve portions and the first substrate are integrally molded as a molded product.

6. A system comprising:
the fluidic device according to any one of claims 1 to 5; and
a drive device configured to press-drive the valve portions of the fluidic device,
wherein the drive device includes:
a movable member that is movable between a first position at which the valve portion is pressed to close the flow path with a tip of the movable member via the through-hole and a second position at which the movable member retreats in a direction of the axis from the first position to open the flow path when the fluidic device is set in the drive device;
a rotation device that is rotatable around the axis; and
a cam portion that is disposed on the same circumference in the rotation device as the valve portions of the fluidic device, supports a base end of the movable member, and is configured to move the movable member in the direction of the axis.

7. The system according to claim 6,
wherein the cam portion includes a peak portion that supports the movable member as the first position and a valley portion that supports the movable member as the second position.

8. The system according to claim 7,
wherein the cam portion includes two or more peak portions and two or more valley portions.

9. The system according to claim 7 or 8,
wherein the cam portion includes an inclined portion between the peak portion and the valley portion.

10. The system according to any one of claims 7 to 9,
wherein the valve portions are disposed at an interval of an angle of 45° centered on the axis, and the peak portion and the valley portion are disposed at an interval of 90°.

11. The system according to any one of claims 7 to 10,
wherein in the three or more valve portions neighboring each other in a circumferential direction, a crossing angle between a straight line connecting the valve portion at a center and the valve portion on one side in the circumferential direction and a straight line connecting the valve portion at the center and the valve portion on another side in the circumferential direction is 135°.
